(19) United States
(12) Patent Application Publication
(10) Pub. No.: US 2010/0067744 A1
(43) Pub. Date: Mar. 18, 2010

(54) Method and Single Laser Device for Detecting Magnifying Optical Systems

(75) Inventors: Jean-Louis Duvent, Nozay (FR); Jean-Yves Thomas, Nozay (FR); Pierre Morin, Villebon Sur Yvette (FR)

Correspondence Address: Dickinson Wright PLLC;James E. Ledbetter, Esq., International Square, 1875 Eye Street, N.W., Suite 1200, Washington, DC, 20006, US

(73) Assignee: COMPAGNIE INDUSTRIELLE DES LASERS CILAS, Orleans (FR)

(21) Appl. No.: 12/595,221

(22) PCT Filed: Apr. 7, 2008
(86) PCT No.: PCT/FR2008/000484

§ 371 Date: Oct. 8, 2009

(30) Foreign Application Priority Data
Apr. 11, 2007 (FR) 07/02629

(51) Int. Cl. G06K 9/00

(52) U.S. Cl. 382/103

(57) ABSTRACT

The invention comprises illuminating a scene where said magnifying optical system (OP) may occur with at least one pulse generated by first laser transmitter (E). The laser transmitter (E) and a first detector of the scene thus illuminated (D1) are adjacent, while a second detector (D2) is remote from said transmitter (E) transversally to the direction (d) of said scene.

The present invention relates to a method and a device for detecting magnifying optical systems.

It is known that magnifying optical systems (such as sighting scopes and eyes) exhibit the property that they retroreflect light. So, to detect such a magnifying optical system situated in a scene, it is known to illuminate said scene by laser pulses and to capture images thereof in synchronism with the corresponding laser illuminations. Thus, a luminous spot corresponding to said magnifying optical system appears on said images.

However, other retroreflecting objects, such as motor vehicle reflectors, signposts, etc., may be situated in said scene thus illuminated. It follows from this that the luminous spots shown by the images do not necessarily correspond to magnifying optical systems and that an ambiguity therefore exists as regards the detection of the latter.

The object of the present invention is to remedy this drawback.

To this end, according to the invention, the method for detecting a magnifying optical system situated in a scene with other objects able to retroreflect light, according to which method said scene is illuminated by at least one laser pulse emitted by a laser emitter and a first image of said scene illuminated by said laser pulse is captured by means of a first detector observing said scene, said first detector and said laser emitter being at least approximately adjacent transversely to the direction of said scene, is noteworthy in that:
said scene is observed by at least one second detector offset from said laser emitter transversely to the direction of said scene;
at least one second image of said scene illuminated by said laser pulse is captured by means of said second detector;
said first and second simultaneous images are compared; and
it is considered that one of said objects is a magnifying optical system if its image is present in said first image of said scene, but absent from said second image of said scene.

Specifically, the Applicant has observed that the retroreflection cone of a magnifying optical system is very narrow (of the order of 0.1 mrads), whereas that of standard reflectors is much wider (at least equal to 50 mrads). Thus, by offsetting said second detector from the emitter, said second detector will be able to receive the emitted light retroreflected by the standard reflectors, but will not see the light retroreflected by a magnifying optical system.

Of course, the transverse offset between the second detector and said emitter making it possible to benefit from the invention depends on the distance separating the second detector and said magnifying optical system, as well as the angle of the latter's retroreflection cone. Nevertheless, experimentation has shown that a fixed transverse offset at least equal to 200 mm, preferably of the order of 400 mm, made it possible to discriminate an optical system from a standard reflector for distances of between a few meters and several kilometers.

It is advantageous to illuminate said scene by means of a series of laser pulses emitted by said laser emitter, to carry out the captures of successive pairs of images each comprising a first image and a second image, which are simultaneous, corresponding to each laser pulse of the series and to successively compare the first image and the second image of each pair of images.

The present invention relates moreover to a device for detecting a magnifying optical system situated in a. scene with other objects able to retroreflect light, said device comprising a laser emitter for illuminating said scene and a first detector able to detect the light retroreflected by said objects illuminated by said emitter, said first detector and said laser emitter being at least approximately adjacent transversely to the direction of said scene, the detection device being noteworthy in that it comprises:
a second detector offset from said laser emitter transversely to the direction of said scene and able to detect the light retroreflected by said objects illuminated by said laser emitter; and
a comparator able to compare the simultaneous images of said scene illuminated by said laser emitter, captured respectively by said first and second detectors.

The figures of the appended drawing will elucidate the manner in which the invention may be embodied. In these figures, identical references denote similar elements.

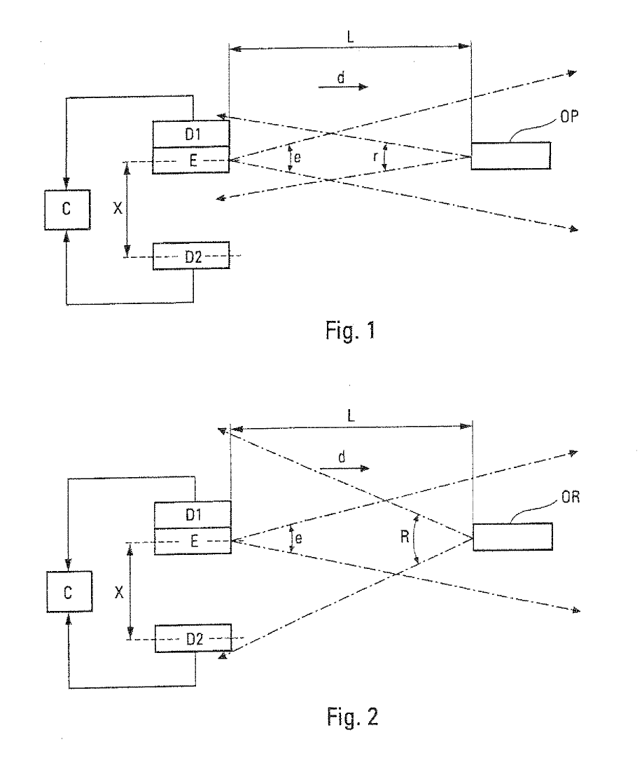

FIG. 1 schematically illustrates the present invention in the case of a magnifying optical system.

FIG. 2 schematically illustrates the present invention in the case of a standard reflector.

Represented in these figures is a device in accordance with the present invention comprising first and second detectors D1 and 02, for example of the CCD matrix type, and a pulse laser emitter E.

The laser emitter E and the first detector D1 are very close to one another and can even form a single physical unit. They are oriented in a direction d, towards a scene which is the distance L away and in which an object OP or OR able to retroreflect light is situated.

On the other hand, the second detector D2 is separated, transversely to the direction d, from the laser emitter E by en offset x.

In FIGS. 1 and 2, the angle of the emission cone of the laser emitter E has been denoted by e.

The retroreflecting object OP, shown in FIG. 1, is a magnifying optical system, such as an eye, a sighting scope, etc. Accordingly, its retroreflection cone is narrow, with an angle r, for example of the order of 0.1 mrads. As a result, as represented in FIG. 1, the light emitted by the emitter E adjacent to the first detector D1 and retroreflected by the magnifying optical system OP in a narrow retroreflection cone such as this, may be received by said first detector D1. On the other hand, this light emitted by said emitter E and retroreflected by the magnifying optical system OP, may not be received by said second detector D2, offset from the emitter E.

Thus, when the retroreflecting object is a magnifying optical system OP, the second detector D2 may not receive the light emitted by the offset emitter E and retroreflected by the magnifying optical system OP.

When, as is represented in FIG. 2, the retroreflecting object is a standard reflector OR, the latter's retroreflection cone is wide, with an angle R, for example at least equal to 50 mrads.

It follows from this that the light emitted by the emitter E and retroreflected by the object OR is received, simultaneously by both said first and second detectors.

The laser emission of the emitter E can consist of a train of laser pulses. For their part, the detectors D1 and D2 are able, in synchronism with said laser pulses respectively, to form first and second images of the scene in which the retroreflecting objects OP and OR are situated.

From the foregoing, it is therefore deduced that:
in the case where the retroreflecting object is a standard reflector OR, said first images and also said second images formed respectively by the detectors D1 and D2 comprise the image of the object OR illuminated by said laser pulses, respectively; and
in the case where the retroreflecting object is a magnifying optical system OP, only said first images formed by said first detector D1 comprise the image of the object OP illuminated by said first laser pulses, said second images formed by said second detector D2 not being able to comprise the image of the object OP illuminated by said laser pulses.

It results from the foregoing that the comparison, carried out in a comparator C, of first and of second simultaneous images formed respectively by said first and second detectors D1 and D2 and corresponding to one and the same laser pulse, makes it possible to consider that:
if the first image and the second image both comprise the image of the retroreflecting object, the latter is a standard reflector; and
if only the first image comprises the image of the retroreflecting object, the latter is a magnifying optical system.

Experimentation has shown that the foregoing was satisfied when the transverse offset x between the emitter E and the second detector D2 was at least equal to 200 mm and, preferably, of the order of 400 mm.

1-7. (canceled)

8. A method for detecting a magnifying optical system (OP) situated in a scene with other objects (OR) able to retroreflect light, according to which method said scene is illuminated by at least one laser pulse emitted by a laser emitter (E) and a first image of said scene illuminated by said laser pulse is captured by a first detector (D1) observing said scene, said first detector (D1) and said laser emitter (E) being at least approximately adjacent transversely to the direction (d) of said scene, said method comprising:
observing said scene by at least one second detector (D2) offset from said laser emitter (E) transversely to the direction (d) of said scene;
capturing at least one second image of said scene illuminated by said laser pulse by said second detector (D2);
comparing said first and second simultaneous images; and
deeming one of said objects to be a magnifying optical system (OP) if its image is present in said first image of said scene, but absent from said second image of said scene.

9. The method as claimed in claim 8, wherein the transverse offset (x) between said second detector (D2) and said laser emitter (E) is at least equal to 200 mm.

10. The method as claimed in claim 9, wherein said transverse offset (x) is of the order of 400 mm.

11. The method as claimed in claim 8, wherein said scene is illuminated by a series of laser pulses emitted by said laser emitter (E), successive pairs of images each comprising a first image and a second image, which are simultaneous, corresponding to each laser pulse of the series are captured and the first image and the second image of each pair of images are compared successively.

12. A device for detecting a magnifying optical system (OP) situated in a scene with other objects (OR) able to retroreflect light, said device comprising:
a laser emitter (E) for illuminating said scene;
a first detector (01) configured to detect the light retroreflected by said objects illuminated by said emitter (E), said first detector (D1) and said laser emitter (E) being at least approximately adjacent transversely to the direction (d) of said scene;
a second detector (02) offset from said laser emitter (E) transversely to the direction (d) of said scene and configured to detect the light retroreflected by said objects illuminated by said emitter; and
a comparator (C) configured to compare the simultaneous images of said scene illuminated by said laser emitter (E), captured respectively by said first and second detectors (D1, D2).

13. The device as claimed in claim 12, wherein the transverse offset (x) between said second detector (D2) and said laser emitter (E) is at least equal to 200 mm.

14. The device as claimed in claim 13, wherein said transverse offset (x) is of the order of 400 mm.
